(19) United States
(12) Patent Application Publication
(10) Pub. No.: US 2014/0136317 A1
(43) Pub. Date: May 15, 2014

(54) ADVERTISEMENT INFORMATION PROVIDING DEVICE AND ADVERTISEMENT INFORMATION PROVIDING METHOD

(71) Applicant: YAHOO JAPAN CORPORATION, Tokyo (JP)

(72) Inventor: Toru HOTTA, Tokyo (JP)

(73) Assignee: YAHOO JAPAN CORPORATION, Tokyo (JP)

(21) Appl. No.: 13/958,048

(22) Filed: Aug. 2, 2013

(30) Foreign Application Priority Data
Nov. 12, 2012 (JP) 2012-248633

(51) Int. Cl. G06Q 30/02

(52) U.S. Cl. CPC G06Q 30/0246
USPC 705/14.45

(57) ABSTRACT

An advertisement information providing device, includes: an advertisement content storing unit configured to store impression-guaranteed type advertisement content and pay-per-click type advertisement content; an advertisement content type determining unit configured to determine which type of advertisement content between the impression-guaranteed type advertisement content and the pay-per-click type advertisement content to deliver when a page browsing request is received from a terminal device of a user; and an advertisement content delivery unit configured to determine advertisement content of the type determined by the advertisement content type determining unit among advertisement content stored in the advertisement content storing unit and deliver the advertisement content determined to an advertisement space included in a page for which the page browsing request is received from the terminal device of the user.

### CROSS-REFERENCE TO RELATED APPLICATIONS

The present application claims priority to and incorporates by reference the entire contents of Japanese Patent Application No. 2012-248633 filed in Japan on Nov. 12, 2012.

### BACKGROUND OF THE INVENTION

1. Field of the Invention

The present invention relates to a technology for providing advertisement information via a network.

2. Description of the Related Art

Online advertising is charged in various manners. Two exemplary methods for charging for the advertisements provided through networks are impression-guaranteed type and Pay-per-Click type.

Impression-guaranteed type guarantees the advertiser that his/her advertisement will be displayed a predetermined number of times within a predetermined period of time. The advertiser pays a set amount of money for the predetermined number of impressions (representations).

Pay-per-Click means that a mere impression of the advertisement does not incur a cost. The cost is incurred only when the user clicks on the advertisement and views a web page showing commodities of the advertiser.

According to impression-guaranteed type, advertisement rate is generally determined based on a large number of impressions. Hence, the cost for each representation of the advertisement is low. Whereas, according to Pay-per-Click, the cost for one click is significantly higher than the cost for one representation in impression-guaranteed type.

Conventionally, the payment method is set in advance for each banner (i.e., advertisement space or ad space) on a web page. For example, only the advertisement whose cost is charged by impression-guaranteed type is displayed in an impression-guaranteed type banner, whereas only the advertisement whose cost is charged by Pay-per-Click is displayed in a Pay-per-Click banner.

Meanwhile, it is noted that the applicant could not find a published document related to the present invention before filing this application. Thus, information on the published document related to the present invention is not provided herein.

Thus, since the type of displayable advertisement is determined in advance for each banner, the profit the publisher (e.g., website owner) can raise from running the advertisement of an advertiser is limited. For example, the profit from the impression-guaranteed type banner can be increased only by increasing the number of impressions, and the Pay-per-Click advertisement which would bring more profit cannot be displayed in the impression-guaranteed type banner.

### SUMMARY OF THE INVENTION

It is an object of the present invention to at least partially solve the problems in the conventional technology.

According to one aspect of an embodiment, an advertisement information providing device, includes: an advertisement content storing unit configured to store impression-guaranteed type advertisement content and pay-per-click type advertisement content; an advertisement content type determining unit configured to determine which type of advertisement content between the impression-guaranteed type advertisement content and the pay-per-click type advertisement content to deliver when a page browsing request is received from a terminal device of a user; and an advertisement content delivery unit configured to determine advertisement content of the type determined by the advertisement content type determining unit among advertisement content stored in the advertisement content storing unit and deliver the advertisement content determined to an advertisement space included in a page for which the page browsing request is received from the terminal device of the user.

According to another aspect of an embodiment, an advertisement information providing method executed by an advertisement information providing device, includes: storing impression-guaranteed type advertisement content and pay-per-click type advertisement content; determining which type of advertisement content to deliver between the impression-guaranteed type advertisement content and the pay-per-click type advertisement content when a page browsing request is received from a terminal device of a user; and determining advertisement content of the type determined in the determining among advertisement content stored in the storing and delivering the advertisement content determined to an advertisement space included in a page for which the page browsing request is received from the terminal device of the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a system configuration of an embodiment of the present invention;

FIG. 2 is a diagram illustrating an example of a data configuration of an advertisement DB (Database);

FIG. 3 is a diagram illustrating an example of a data configuration of a behavior history DB;

FIG. 4 is a diagram illustrating an example of a data configuration of an advertisement DB;

FIG. 5 is a sequence diagram (1) illustrating an example process of the embodiment;

FIG. 6 is a sequence diagram (2) illustrating an example process of the embodiment;

FIG. 7 is a sequence diagram (3) illustrating an example process of the embodiment;

FIG. 8 is a sequence diagram (4) illustrating an example process of the embodiment;

FIG. 9 is a sequence diagram (5) illustrating an example process of the embodiment;

FIG. 10 is a sequence diagram (6) illustrating an example process of the embodiment; and

FIG. 11 is a sequence diagram (7) illustrating an example process of the embodiment.

### DETAILED DESCRIPTION OF THE PREFERRED EMBODIMENTS

Preferred embodiments of the present invention will be described.

Configuration

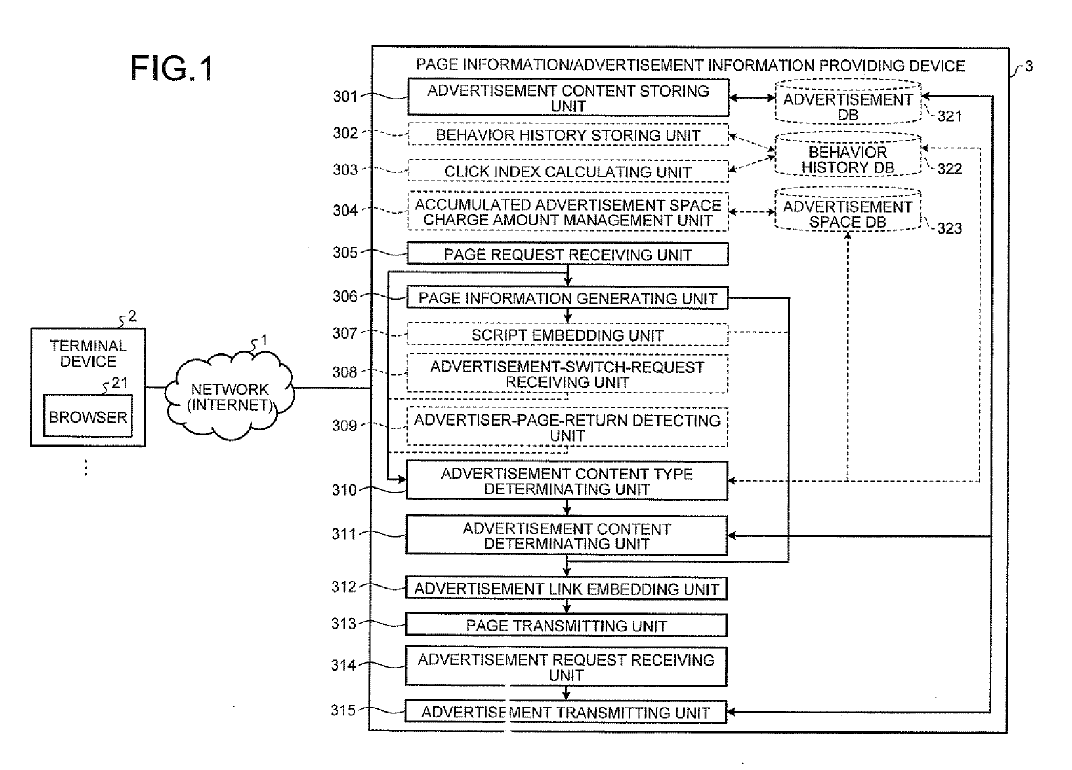

FIG. 1 is a diagram illustrating an example of a system configuration according to an embodiment of the present invention.

In FIG. 1, terminal devices 2 such as a Smartphone, a mobile phone, a personal computer (PC) operated by a user are connected to a network 1 such as the Internet. The terminal device 2 includes a general browser (web browser) 21. The browser 21 has a function for requesting, acquiring, and displaying page data described in a language such as an HTML (Hyper Text Markup Language) and sending form data, according to a standard Internet protocol such as an HTTP (Hyper Text Transfer Protocol).

Further, a page information/advertisement information providing device 3 which provides page information and advertisement information in response to a request from the terminal device 2 is connected to the network 1.

The page information/advertisement information providing device 3 includes, as functional units, an advertisement content storing unit 301, a behavior history storing unit 302, a click index calculating unit 303, an accumulated advertisement space charge amount managing unit 304, a page request receiving unit 305, a page information generating unit 306, a script embedding unit 307, an advertisement-switch-request receiving unit 308, an advertiser-page-return detecting unit 309, an advertisement content type determining unit 310, an advertisement content determining unit 311, an advertisement link embedding unit 312, a page transmitting unit 313, an advertisement request receiving unit 314, and an advertisement transmitting unit 315.

These functional units are computer programs run on hardware resources such as a CPU (Central Processing Unit), ROM (Read Only Memory), RAM (Random Access Memory) and the like in a computer which constitutes the page information/advertisement information providing device 3. These functional units do not have to be provided in a single computer and can be provided separately according to need.

Further, as databases used by the page information/advertisement information providing device 3, there are an advertisement DB 321, a behavior history DB 322, and an advertisement space DB 323. These databases systematically include predetermined data in a storage medium such as an HDD (Hard Disk Drive) in the computer constituting the page information/advertisement information providing device 3. Note that the advertisement DB 321, the behavior history DB 322, and the advertisement space DB 323 do not have to be provided in the page information/advertisement information providing device 3 and can be provided in another device. Further, as advertisement content, there are an impression-guaranteed type piece and a pay-per-click type piece which will be described later. Since different types of advertisement content generally have different formats when submitted, the advertisement DB 321 can be separately provided for each type of advertisement content.

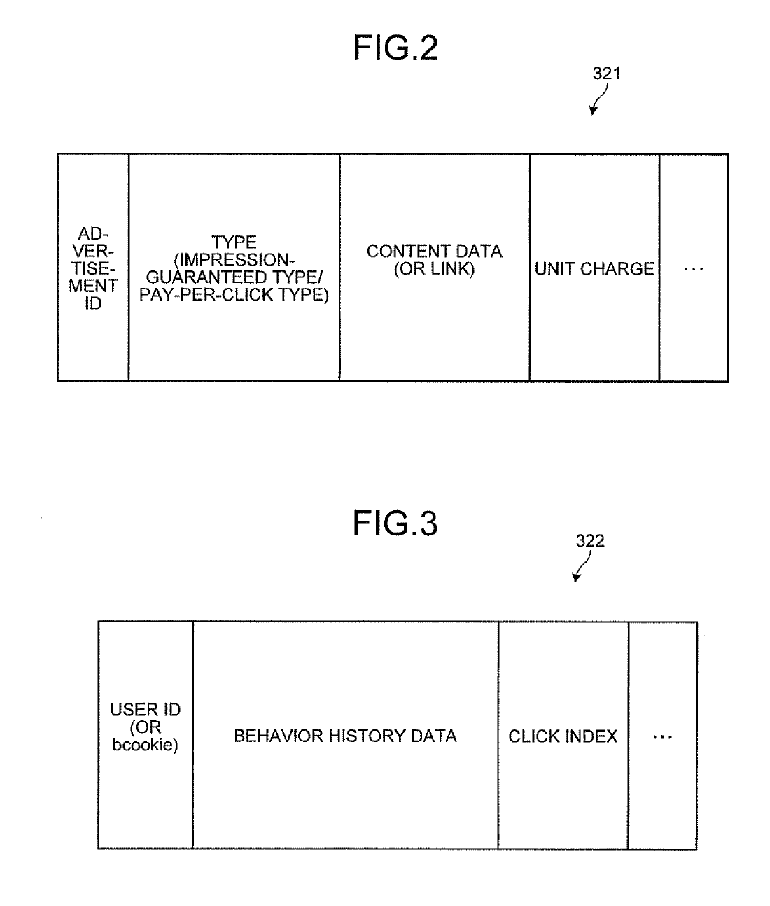

FIG. 2 is a diagram illustrating an example of a data configuration of the advertisement DB 321, which includes items (fields) such as “advertisement ID,” “type,” “content data,” and “unit charge.” The “advertisement ID” is information that identifies advertisement content. The “type” is information that indicates types of advertisement content, which are the impression-guaranteed type and pay-per-click type in an embodiment. The “content data” is advertisement data itself or link information of a stored location of the advertisement content. The “unit charge” is a unit price per one display in the case of the impression-guaranteed type advertisement content and a unit price per one click in the case of the pay-per-click type advertisement content.

FIG. 3 is a diagram illustrating an example of a data configuration of the behavior history DB 322, which includes items of “user ID,” “behavior history data,” “click index” and the like. The “user ID” is information that identifies users and includes a member ID that specifically identifies a user, bcookie (written as browser cookie information at a first access and will be referred at later accesses) that identifies an access from the same browser, and the like. The “behavior history data” is a history of viewing and clicking of the user (including information of a target advertisement content, date and time.) The “click index” is a value calculated based on the “behavior history data” and indicates a user's tendency to click an advertisement.

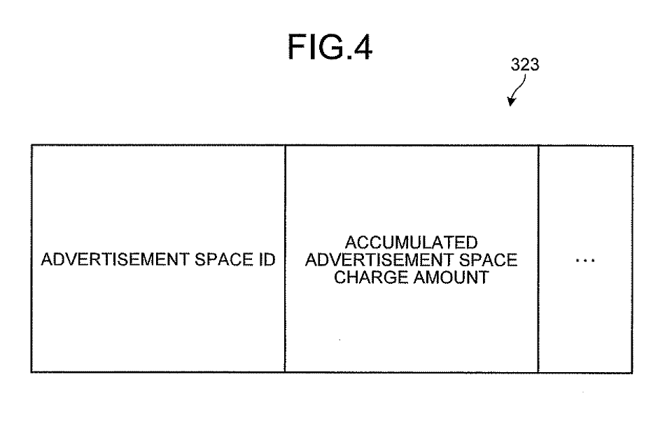

FIG. 4 is a diagram illustrating an example of a data configuration of the advertisement space DB 323, which includes items of “advertisement space ID,” “accumulated advertisement space charge amount” and the like. The “advertisement space ID” is information that identifies an advertisement space. The “accumulated advertisement space charge amount” is an accumulated value of charges of advertisement content displayed in the advertisement space. For example, regarding the impression-guaranteed type advertisement content, the unit charge stored in the advertisement DB 321 is added corresponding to every display of the advertisement. Regarding the pay-per-click type advertisement content, the unit charge stored in the advertisement DB 321 is added corresponding to every user's click on a displayed advertisement.

Referring back to FIG. 1, the advertisement content storing unit 301 of the page information/advertisement information providing device 3 has a function to store, at a predetermined timing, an advertisement ID, a type and content data in the advertisement DB 321 for each piece of advertisement content provided by an advertiser.

The behavior history storing unit 302 has a function to monitor user's behaviors of browsing and clicking on the browser 21 of the terminal device 2, associate the behavior history data with a user ID and store the data in the behavior history DE 322.

The click index calculating unit 303 has a function to refer to the behavior history DB 322 periodically or at a predetermined timing (for example, when a click index is required), calculate a click index of each user based on behavior history data and store the click index in the behavior history DB 322. The click index is, for example, a CTR (Click Through Rate or Click Through Ratio) that is a ratio of the number of clicks corresponding to the number of times an advertisement is displayed.

The accumulated advertisement space charge amount managing unit 304 has a function to monitor the display of advertisement content in an advertisement space and user's clicks on the displayed advertisement content, and update the accumulated advertisement space charge amount of each piece of advertisement content in the advertisement space DB 323.

The page request receiving unit 305 has a function to receive a page browsing request from the browser 21 of the terminal device 2.

The page information generating unit 306 has a function to generate page information corresponding to the received page browsing request. The generated page includes an advertisement space.

The script embedding unit 307 has a function to embed a script, into the page generated by the page information generating unit 306, for computing display time of the page and sending an advertisement switch request to the page information/advertisement information providing device 3 when a predetermined period of time elapses.

The advertisement-switch-request receiving unit 308 has a function to receive an advertisement switch request from the browser 21 of the terminal device 2 when the display time of the page having the script embedded by the script embedding unit 307 reaches the predetermined period of time.

The advertiser-page-return detecting unit 309 has a function to detect a reception of a page browsing request which requests a return to a previous page after impression-guaranteed type advertisement content is clicked and an advertiser page is displayed.

The advertisement content type determining unit 310 has a function to determine which type of advertisement content between impression-guaranteed type advertisement content and pay-per-click type advertisement content is to be delivered, when a page browsing request is received from the browser 21 of the terminal device 2.

The advertisement content determining unit 311 has a function to determine a piece of advertisement content to be delivered from pieces of advertisement content of the type determined by the advertisement content type determining unit 310 and stored in the advertisement DB 321. The advertisement content determining unit 311 may determine the piece of advertisement content to be delivered according to various methods; for example, the advertisement content determining unit 311 may pick up the piece randomly from pieces of advertisement content of the determined type, or the advertisement content determining unit 311 may pick up the piece based on usage rate or priority.

The advertisement link embedding unit 312 has a function to embed a link to the piece of advertisement content determined to be delivered by the advertisement content determining unit 311 into the advertisement space of the page generated by the page information generating unit 306. The link is, for example, a URL of the page information/advertisement information providing device 3 added with an advertisement ID as a parameter. Here, the advertisement content data itself can be embedded, as a substitute for the link.

The page transmitting unit 313 has a function to transmit page information to the browser 21 of the terminal device 2, which is a requester.

The advertisement request receiving unit 314 has a function to receive an advertisement content request based on the link embedded in the advertisement space during a process that the browser 21 of the terminal device 2 renders a screen based on the page information. When the advertisement content itself is embedded in the advertisement space, the advertisement content request is not sent.

The advertisement transmitting unit 315 has a function to transmit advertisement content data to the browser 21 of the terminal device 2 as a requester when the advertisement request receiving unit 314 receives an advertisement content request.

Operation: Determining Type Based on Click Index

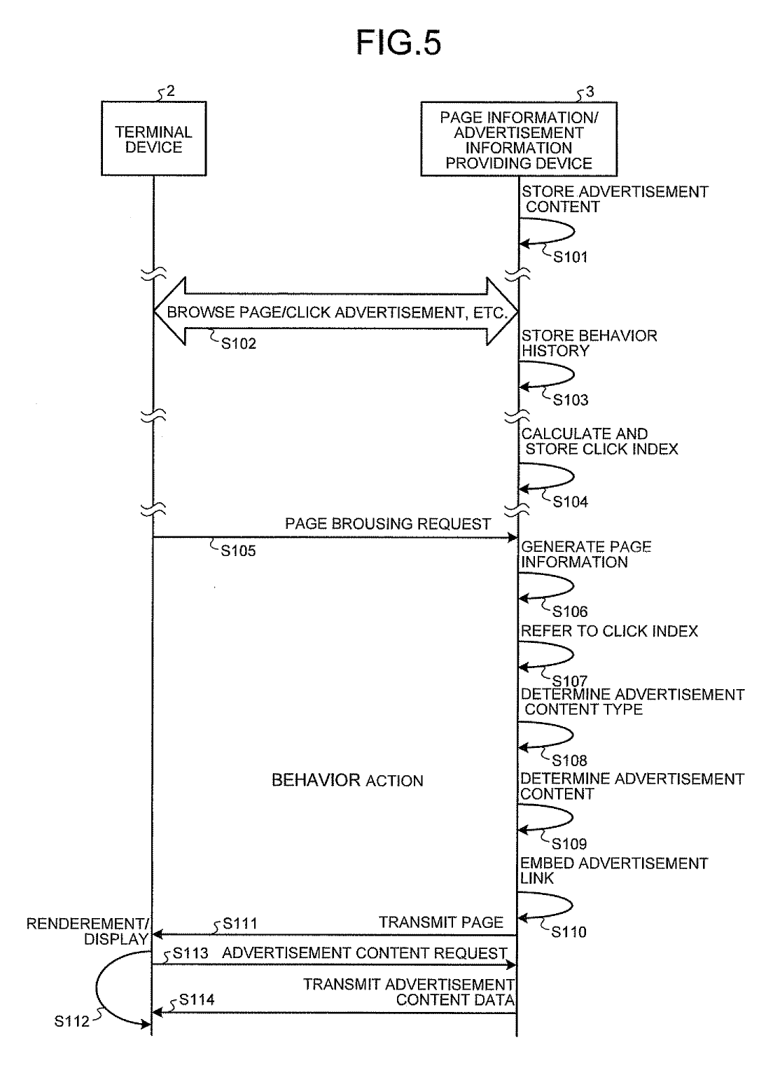

FIG. 5 is a sequence diagram illustrating an example process of an embodiment.

In FIG. 5, the advertisement content storing unit 301 of the page information/advertisement information providing device 3 stores, at a predetermined timing, an advertisement ID, a type and content data of advertisement content provided from an advertiser in the advertisement DB 321 (step S101).

After that, when a user browses a page or clicks on the browser 21 of the terminal device 2 (step S102), the behavior history storing unit 302 of the page information/advertisement information providing device 3 associates behavior history data with a user ID and stores the data in the behavior history DB 322 (step S103).

After that, the click index calculating unit 303 of the page information/advertisement information providing device 3 refers, periodically or at a predetermined timing, to the behavior history DB 322, calculates a click index of each user based on the behavior history data, and stores the click index in the behavior history DB 322 (step S104).

After that, the browser 21 of the terminal device 2 transmits a page browsing request and the page request receiving unit 305 of the page information/advertisement information providing device 3 receives the page browsing request (step S105), and the page information generating unit 306 of the page information/advertisement information providing device 3 generates page information corresponding to the received page browsing request (step S106).

Then, the advertisement content type determining unit 310 of the page information/advertisement information providing device 3 refers to the click index in the behavior history DB 322 by using the user ID of the user (step S107), and determines which type of advertisement content between the impression-guaranteed type advertisement content and the pay-per-click type advertisement content to deliver (step S108). For example, when a click index is not more than a predetermined threshold value, the advertisement content type determining unit 310 determines the type of advertisement content to be delivered to be the impression-guaranteed type for which cost can be charged when it is displayed because the possibility of clicking is low and, when a click index is more than the predetermined threshold value, the advertisement content type determining unit 310 determines the type of advertisement content to be delivered to be the pay-per-click type for which a higher cost can be charged.

Then, the advertisement content determining unit 311 of the page information/advertisement information providing device 3 determines a piece of advertisement content to be delivered from pieces of advertisement content of the type determined by the advertisement content type determining unit 310 and stored in the advertisement DB 321 (step S109).

Then, the advertisement link embedding unit 312 of the page information/advertisement information providing device 3 embeds a link to the piece of advertisement content determined by the advertisement content determining unit 311 into an advertisement space of the page generated by the page information generating unit 306 (step S110).

Then, the page transmitting unit 313 of the page information/advertisement information providing device 3 transmits the page information to the browser 21 of the terminal device 2 as the requestor (step S111).

Upon receiving the information, the browser 21 of the terminal device 2 renders and displays a screen based on the page information (step S112) and, during this process, sends an advertisement content request using the link embedded in the advertisement space (step S113).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as a requestor (step S114). Alternatively, an advertisement delivery server may be provided to receive redirection of an advertisement request from the advertisement space in which the page is displayed, and deliver advertisement content data. This can be applied to other operation examples.

Operation: Determining Type Based on Accumulated Advertisement Space Charge Amount

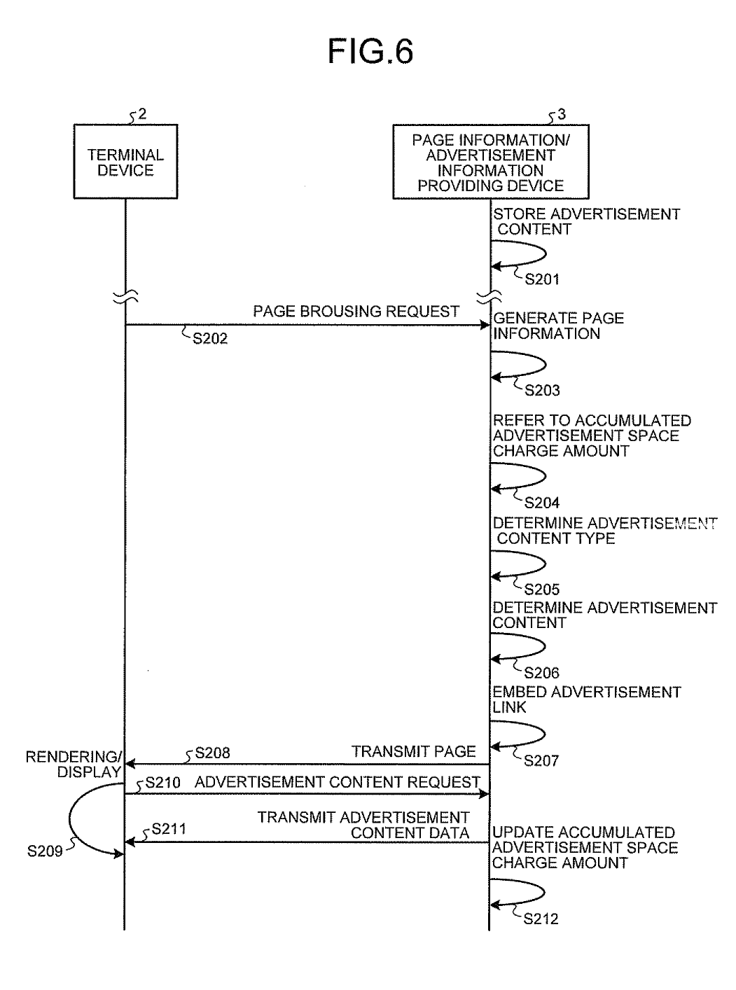

FIG. 6 is a sequence diagram illustrating an example process of an embodiment.

In FIG. 6, the advertisement content storing unit 301 of the page information/advertisement information providing device 3 stores, at a predetermined timing, an advertisement ID, a type and content data of advertisement content provided from an advertiser in the advertisement DB 321 (step S201).

After that, when the browser 21 of the terminal device 2 transmits a page browsing request and the page request receiving unit 305 of the page information/advertisement information providing device 3 receives the page browsing request (step S202), the page information generating unit 306 of the page information/advertisement information providing device 3 generates page information corresponding to the received page browsing request (step S203).

Then, the advertisement content type determining unit 310 of the page information/advertisement information providing device 3 refers to an accumulated advertisement space charge amount in the advertisement space DB 323 by using an advertisement space ID of the advertisement space (step S204), and determines which type of advertisement content between the impression-guaranteed type advertisement content and the pay-per-click type advertisement content to deliver (step S205). For example, the advertisement content type determining unit 310 determines the type of advertisement content to be delivered to be the impression-guaranteed type for which cost can be charged when it is displayed until the accumulated charge amount reaches a predetermined amount, and the advertisement content type determining unit 310 determines the type of advertisement content to be delivered to be the pay-per-click type after the accumulated charge amount reaches the predetermined amount.

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S206).

Then, the advertisement link embedding unit 312 of the page information/advertisement information providing device 3 embeds a link to the piece of advertisement content determined by the advertisement content determining unit 311 into an advertisement space of the page generated by the page information generating unit 306 (step S207).

Then, the page transmitting unit 313 of the page information/advertisement information providing device 3 transmits the page information to the browser 21 of the terminal device 2 as the requestor (step S208).

Upon receiving the information, the browser 21 of the terminal device 2 renders and displays a screen based on the page information (step S209) and, during this process, sends an advertisement content request using the link embedded in the advertisement space (step S210).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requestor (step S211).

Then, the accumulated advertisement space charge amount managing unit 304 of the page information/advertisement information providing device 3 updates the accumulated advertisement space charge amount in the advertisement space DB 323 for each piece of advertisement content based on displays of advertisement content in the advertisement space or user's clicks on displayed advertisement content (step S212). Specifically, when the advertisement content is the impression-guaranteed type, the unit charge in the advertisement DB 321 is added to the accumulated advertisement space charge amount corresponding to every display. When the advertisement content is the pay-per-click type, the unit charge in the advertisement DB 321 is added to the accumulated advertisement space charge amount corresponding to every click.

Operation: Determining Type Based on Accumulated Advertisement Space Charge Amount and Click Index

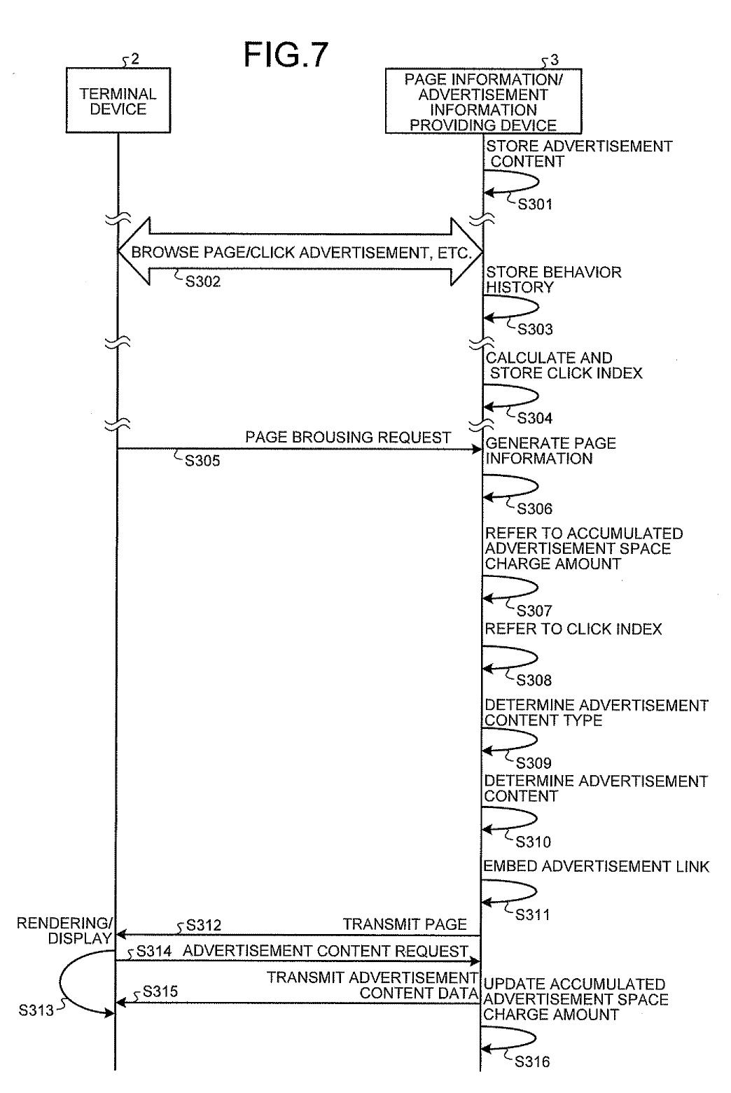

FIG. 7 is a sequence diagram of an example process of an embodiment.

In FIG. 7, the advertisement content storing unit 301 of the page information/advertisement information providing device 3 stores, at a predetermined timing, an advertisement ID, a type and content data of advertisement content provided from an advertiser in the advertisement DB 321 (step S301).

After that, when a user browses a page or clicks on the browser 21 of the terminal device 2 (step S302), the behavior history storing unit 302 of the page information/advertisement information providing device 3 associates behavior history data with a user ID and stores the data in the behavior history DB 322 (step S303).

After that, the click index calculating unit 303 of the page information/advertisement information providing device 3 refers, periodically or at a predetermined timing, to the behavior history DB 322, calculates a click index of each user based on the behavior history data and stores the click index in the behavior history DB 322 (step S304).

After that, when the browser 21 of the terminal device 2 sends a page browsing request and the page request receiving unit 305 of the page information/advertisement information providing device 3 receives the page browsing request (step S305), the page information generating unit 306 of the page information/advertisement information providing device 3 generates page information corresponding to the received page browsing request (step S306).

Then, the advertisement content type determining unit 310 of the page information/advertisement information providing device 3 refers to the accumulated advertisement space charge amount in the advertisement space DB 323 by using an advertisement space ID of the advertisement space (step S307).

Here, when the accumulated charge amount does not reach a predetermined amount, the advertisement content type determining unit 310 of the page information/advertisement information providing device 3 determines the type of advertisement content to be delivered to be the impression-guaranteed type (step S309) without performing the following click index reference (step S308).

On the other hand, when the accumulated charge amount is more than the predetermined amount, the advertisement content type determining unit 310 of the page information/advertisement information providing device 3 refers to the click index in the behavior history DB 322 by using the user ID of the user (step S308) and determines which type of advertisement content between the impression-guaranteed type advertisement content and the pay-per-click type advertisement content to deliver (step S309). For example, when the click index is not more than a predetermined threshold value, the advertisement content type determining unit 310 determines the type of advertisement content to be delivered to be the impression-guaranteed type for which cost can be charged when it is displayed since the possibility of clicking is low and, when the click index is more than the predetermined threshold value, the advertisement content type determining unit 310 determines the type of advertisement content to be delivered to be the pay-per-click type for which a higher cost can be charged.

Then, the advertisement content determining unit 311 of the page information/advertisement information providing device 3 determines a piece of advertisement content to be delivered from pieces of the advertisement content of the type determined by the advertisement content type determining unit 310 and stored in the advertisement DB 321 (step S310).

Then, the advertisement link embedding unit 312 of the page information/advertisement information providing device 3 embeds a link to the advertisement content determined by the advertisement content determining unit 311 into an advertisement space of the page generated by the page information generating unit 306 (step S311).

Then, the page transmitting unit 313 of the page information/advertisement information providing device 3 transmits page information to the browser 21 of the terminal device 2 as the requestor (step S312).

Upon receiving the information, the browser 21 of the terminal device 2 renders and displays a screen based on the page information (step S313) and, during this process, sends an advertisement content request using the link embedded in the advertisement space (step S314).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requestor (step S315).

Then, the accumulated advertisement space charge amount managing unit 304 of the page information/advertisement information providing device 3 updates the accumulated advertisement space charge amount of the advertisement content in the advertisement space DB 323 based on a display of advertisement content in the advertisement space or user's click on the displayed advertisement content (step S316). Specifically, when the advertisement content is the impression-guaranteed type, the unit charge in the advertisement DB 321 is added to the accumulated advertisement space charge amount corresponding to every display. When the advertisement content is the pay-per-click type, the unit charge in the advertisement DB 321 is added to the accumulated advertisement space charge amount corresponding to every click.

Operation: Determining Type Based on Page Display Time

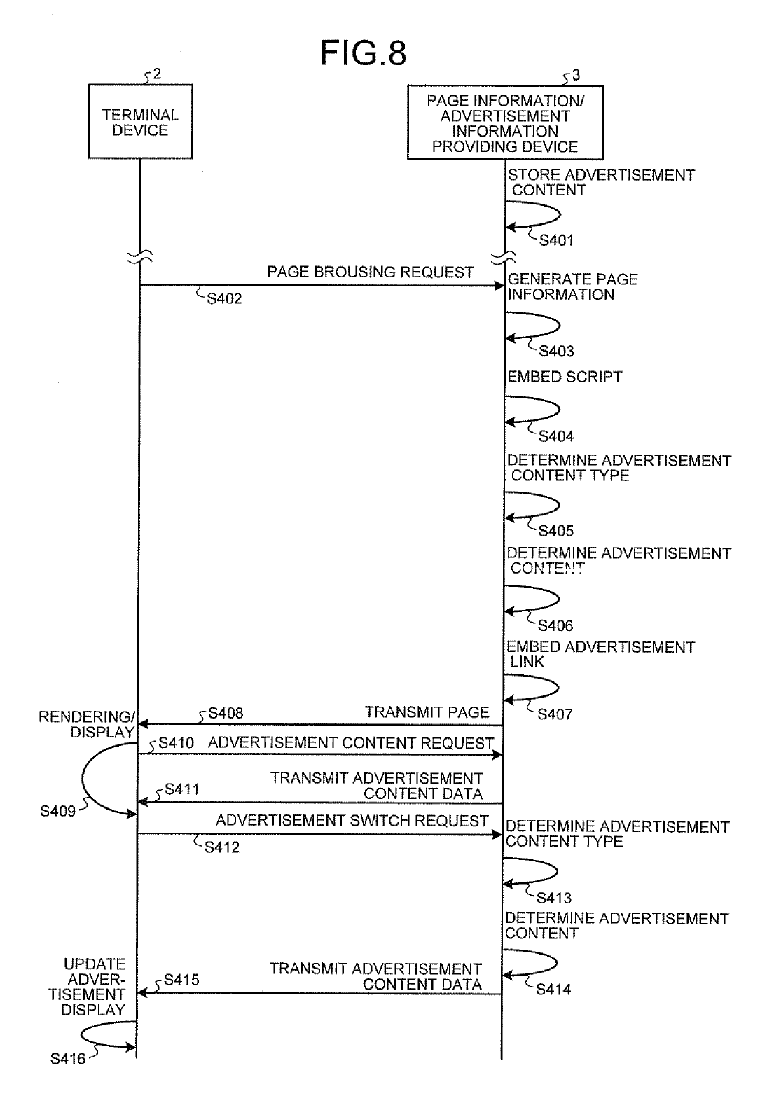

FIG. 8 is a sequence diagram illustrating an example process of an embodiment.

In FIG. 8, the advertisement content storing unit 301 of the page information/advertisement information providing device 3 stores, at a predetermined timing, an advertisement ID, a type and content data of advertisement content provided from an advertiser in the advertisement DB 321 (step S401).

After that, when the browser 21 of the terminal device 2 sends a page browsing request and the page request receiving unit 305 of the page information/advertisement information providing device 3 receives the page browsing request (step S402), the page information generating unit 306 of the page information/advertisement information providing device 3 generates page information corresponding to the received page browsing request (step S403).

Then, the script embedding unit 307 of the page information/advertisement information providing device 3 embeds a script, to the page generated by the page information generating unit 306, for computing display time of the page and sending an advertisement switch request to the page information/advertisement information providing device 3 when a predetermined period of time elapses (step S404).

Then, the advertisement content type determining unit 310 of the page information/advertisement information providing device 3 temporarily determines the type of advertisement content to be delivered to be the impression-guaranteed type for which cost can be charged when it is displayed (step S405).

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S406).

Then, the advertisement link embedding unit 312 of the page information/advertisement information providing device 3 embeds a link to the piece of advertisement content determined by the advertisement content determining unit 311 into an advertisement space of the page generated by the page information generating unit 306 (step S407).

Then, the page transmitting unit 313 of the page information/advertisement information providing device 3 transmits page information to the browser 21 of the terminal device 2 as the requestor (step S408).

Upon receiving the information, the browser 21 of the terminal device 2 renders and displays a screen based on the page information (step S409) and, during this process, sends an advertisement content request using the link embedded in the advertisement space (step S410).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requestor (step S411).

After that, when the display time of the page having the embedded script reaches the predetermined time, the browser 21 of the terminal device 2 sends an advertisement switch request. When the advertisement-switch-request receiving unit 308 of the page information/advertisement information providing device 3 receives an advertisement switch request (step S412), the advertisement content type determining unit 310 of the page information/advertisement information providing device 3 determines the type of advertisement content to be delivered to be the pay-per-click type for which a higher price can be charged because there is a high possibility that the advertisement content is clicked (step S413).

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S414), and the advertisement transmitting unit 315 of the page information/advertisement information providing device 3 transmits corresponding advertisement content data to the browser 21 of the terminal device 2 as the requestor (step S415).

The browser 21 of the terminal device 2 updates, with the function of the script, the display of the advertisement space based on the received advertisement content data (step S416).

Operation: Determining Type Based on Page Display Time and Click Index

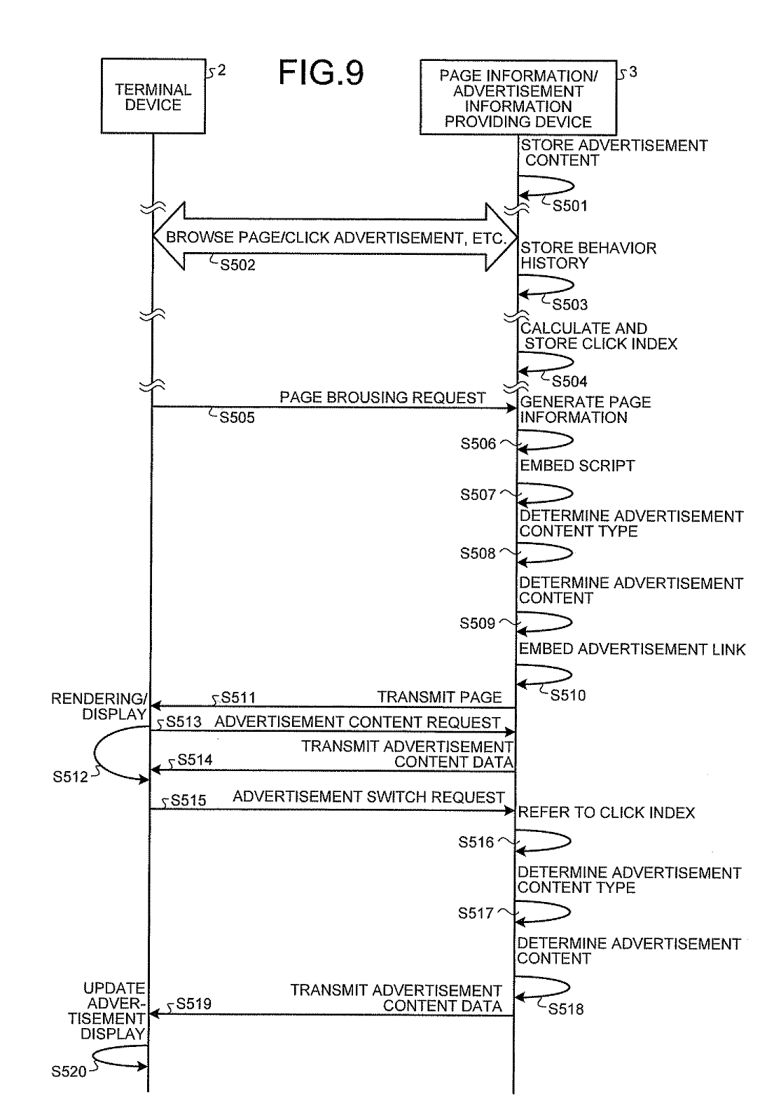

FIG. 9 is a sequence diagram illustrating an example process of an embodiment.

In FIG. 9, the advertisement content storing unit 301 of the page information/advertisement information providing device 3 stores, at a predetermined timing, an advertisement ID, a type and content data of advertisement content provided from an advertiser in the advertisement DB 321 (step S501).

After that, when a user browses a page or clicks on the browser 21 of the terminal device 2 (step S502), the behavior history storing unit 302 of the page information/advertisement information providing device 3 associates behavior history data with a user ID and stores the data in the behavior history DB 322 (step S503).

After that, the click index calculating unit 303 of the page information/advertisement information providing device 3, periodically or at a predetermined timing, refers to the behavior history DB 322, calculates a click index of each user based on the behavior history data and stores the click index in the behavior history DB 322 (step S504).

After that, when the browser 21 of the terminal device 2 sends a page browsing request and the page request receiving unit 305 of the page information/advertisement information providing device 3 receives the page browsing request (step S505), the page information generating unit 306 of the page information/advertisement information providing device 3 generates page information corresponding to the received page browsing request (step S506).

Then, the script embedding unit 307 of the page information/advertisement information providing device 3 embeds a script, to the page generated by the page information generating unit 306, for computing display time of the page and transmitting an advertisement switch request to the page information/advertisement information providing device 3 when a predetermined period of time elapses (step S507).

Then, the advertisement content type determining unit 310 of the page information/advertisement information providing device 3 temporarily determines the type of the advertisement content to be delivered to be the impression-guaranteed type for which cost can be charged when it is displayed (step S508).

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S509).

Then, the advertisement link embedding unit 312 of the page information/advertisement information providing device 3 embeds a link to the piece of advertisement content determined by the advertisement content determining unit 311 into an advertisement space of the page generated by the page information generating unit 306 (step S510).

Then, the page transmitting unit 313 of the page information/advertisement information providing device 3 transmits the page information to the browser 21 of the terminal device 2 as the requestor (step S511).

Upon receiving the information, the browser 21 of the terminal device 2 renders and displays a screen based on the page information (step S512) and, during this process, sends an advertisement content request using the link embedded in the advertisement space (step S513).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requestor (step S514).

After that, when the display time of the page having the embedded script reaches a predetermined period of time, the browser 21 of the terminal device 2 sends an advertisement switch request. When the advertisement-switch-request receiving unit 308 of the page information/advertisement information providing device 3 receives the advertisement switch request (step S515), the advertisement content type determining unit 310 of the page information/advertisement information providing device 3 refers to the click index in the behavior history DB 322 by using the user ID of the user (step S516) and determines which type of advertisement content between the impression-guaranteed type advertisement content and the pay-per-click type advertisement content to deliver (step S517). For example, when the click index is not more than a predetermined threshold value, the advertisement content type determining unit 310 determines the type of advertisement content to be delivered to be the impression-guaranteed type for which cost can be charged when it is displayed since the possibility of clicking is low and, when the click index is more than the predetermined threshold value, the advertisement content type determining unit 310 determines the type of advertisement content to be delivered to be the pay-per-click type for which a higher price can be charged.

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S518), and the advertisement transmitting unit 315 of the page information/advertisement information providing device 3 transmits corresponding advertisement content data to the browser 21 of the terminal device 2 as the requestor (step S519). Here, when the type is not switched to the pay-per-click type and remains to be the impression-guaranteed type, an advertisement switch does not have to be performed and a new advertisement content data does not have to be transmitted.

The browser 21 of the terminal device 2 updates, using a function of the script, the display of the advertisement space based on the received advertisement content data (step S520).

Operation: Determining Type Based on Advertiser Page Route

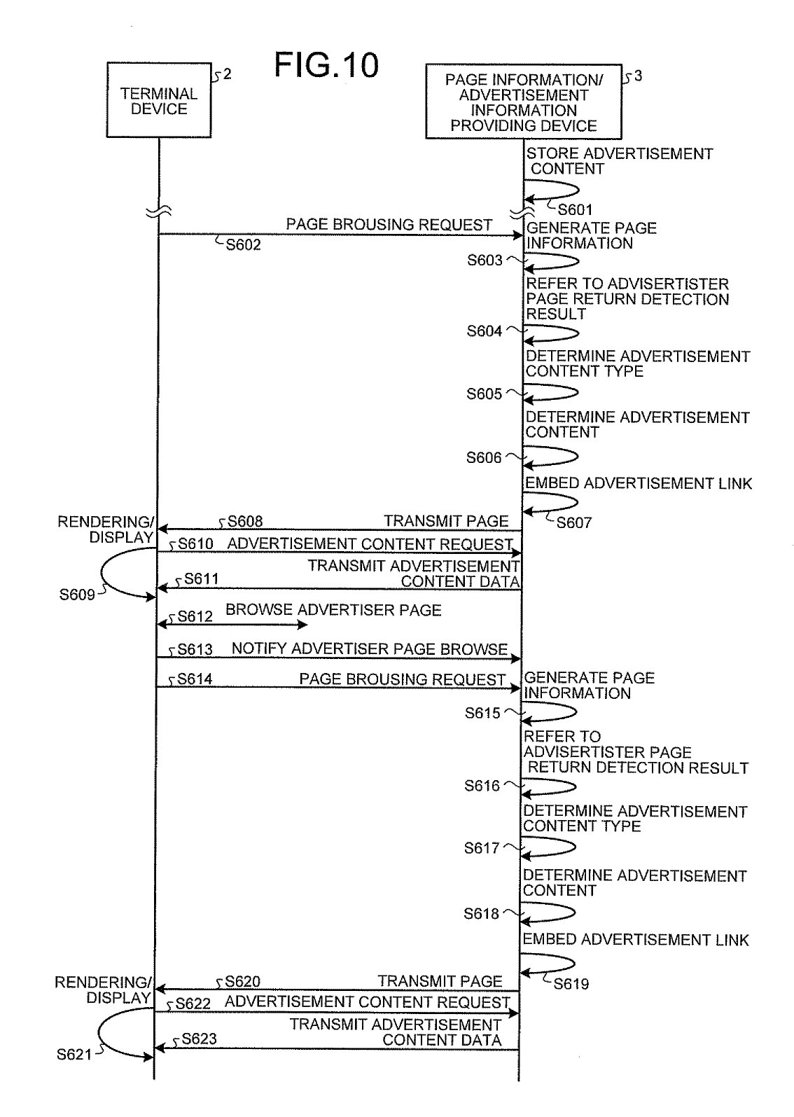

FIG. 10 is a sequence diagram illustrating an example process of an embodiment.

In FIG. 10, the advertisement content storing unit 301 of the page information/advertisement information providing device 3 stores, at a predetermined timing, an advertisement ID, a type and content data of advertisement content provided from an advertiser in the advertisement DB 321 (step S601).

After that, when the browser 21 of the terminal device 2 sends a page browsing request and the page request receiving unit 305 of the page information/advertisement information providing device 3 receives the page browsing request (step S602), the page information generating unit 306 of the page information/advertisement information providing device 3 generates page information corresponding to the received page browsing request (step S603).

Then, the advertisement content type determining unit 310 of the page information/advertisement information providing device 3 refers to the advertiser-page-return detecting unit 309 to check if the advertiser-page-return detecting unit 309 detects an advertiser page return, in other words, if the page browsing request is a request to return to a previous page after the impression-guaranteed type advertisement content is clicked and advertiser page is displayed (step S604).

Here, when an advertiser page return is not detected, the advertisement content type determining unit 310 of the page information/advertisement information providing device 3 temporarily determines the type of advertisement content to be delivered to be the impression-guaranteed type for which cost can be charged when it is displayed (step S605).

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S606).

Then, the advertisement link embedding unit 312 of the page information/advertisement information providing device 3 embeds a link to the piece of advertisement content determined by the advertisement content determining unit 311 into an advertisement space of the page generated by the page information generating unit 306 (step S607).

Then, the page transmitting unit 313 of the page information/advertisement information providing device 3 transmits the page information to the browser 21 of the terminal device 2 as the requester (step S608).

Upon receiving the information, the browser 21 of the terminal device 2 renders and displays a screen based on the page information (step S609) and, during this process, sends an advertisement content request using the link embedded in the advertisement space (step S610).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requestor (step S611).

After that, when the user of the terminal device 2 browses the advertiser's page by clicking the displayed impression-guaranteed type advertisement content (step S612), an advertiser page browse notification to the page information/advertisement information providing device 3 is performed using a notification description embedded in the advertisement space, and the advertiser-page-return detecting unit 309 of the page information/advertisement information providing device 3 detects the notification (step S613). The advertiser page may be provided by a server other than the page information/advertisement information providing device 3. When the advertiser page is provided by the page information/advertisement information providing device 3, the page information of the advertiser page is also provided by the page information/advertisement information providing device 3, though a detailed description thereof is not provided herein.

After that, when the browser 21 of the terminal device 2 sends a page browsing request and the page request receiving unit 305 of the page information/advertisement information providing device 3 receives the page browsing request (step S614), the page information generating unit 306 of the page information/advertisement information providing device 3 generates page information corresponding to the received page browsing request (step S615).

Then, the advertisement content type determining unit 310 of the page information/advertisement information providing device 3 refers to the advertiser-page-return detecting unit 309 to check if the advertiser-page-return detecting unit 309 detects an advertiser page return, in other words, if the page browsing request is a request to return to a previous page after the impression-guaranteed type advertisement content is clicked and the advertiser page is displayed (step S616).

In this situation, the advertisement content type determining unit 310 of the page information/advertisement information providing device 3 determines the type to be delivered to be pay-per-click type for which a higher price can be charged because the advertiser page return is detected and hence there is a high possibility that the advertisement content will be clicked (step S617).

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S618). In this case, since the advertiser page is browsed by clicking and there is a high possibility that the user is interested in the advertisement, it is preferable that advertisement content of the same advertisement subject (product or service) or advertisement content of the same advertiser be selected.

Then, the advertisement link embedding unit 312 of the page information/advertisement information providing device 3 embeds a link to the advertisement content determined by the advertisement content determining unit 311 into an advertisement space of the page generated by the page information generating unit 306 (step S619).

Then, the page transmitting unit 313 of the page information/advertisement information providing device 3 transmits the page information to the browser 21 of the terminal device 2 as the requester (step S620).

Upon receiving the information, the browser 21 of the terminal device 2 renders and displays a screen based on the page information (step S621) and, during the process, sends an advertisement content request using the link embedded in the advertisement space (step S622).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requestor (step S623).

Operation: Determining Type Based on Advertiser Page Route and Click Index

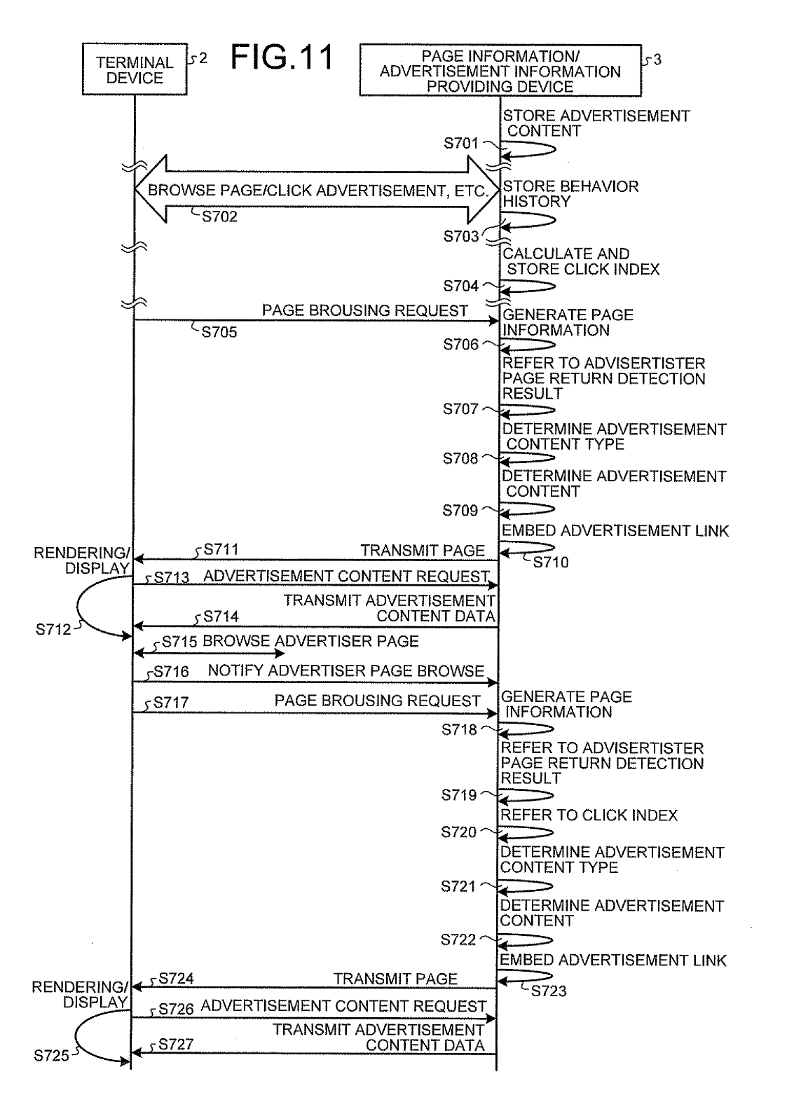

FIG. 11 is a sequence diagram illustrating an example process of an embodiment.

In FIG. 11, the advertisement content storing unit 301 of the page information/advertisement information providing device 3 stores, at a predetermined timing, an advertisement ID, a type and content data of advertisement content provided by an advertiser in the advertisement DB 321 (step S701).

After that, when a user operates the browser 21 of the terminal device 2 to browse a page or clicks (step S702), the behavior history storing unit 302 of the page information/advertisement information providing device 3 associates behavior history data with a user ID and stores the data in the behavior history DB 322 (step S703).

After that, the click index calculating unit 303 of the page information/advertisement information providing device 3 refers, periodically or at a predetermined timing, to the behavior history DB 322 and calculates a click index of each user based on the behavior history data and stores the click index in the behavior history DB 322 (step S704).

After that, when the browser 21 of the terminal device 2 sends a page browsing request and the page request receiving unit 305 of the page information/advertisement information providing device 3 receives the page browsing request (step S705), the page information generating unit 306 of the page information/advertisement information providing device 3 generates page information corresponding to the received page browsing request (step S706).

Then, the advertisement content type determining unit 310 of the page information/advertisement information providing device 3 refers to the advertiser-page-return detecting unit 309 to check if the advertiser-page-return detecting unit 309 detects an advertiser page return, in other words, if the page browsing request is a request to return a previous page after the impression-guaranteed type advertisement content is clicked and the advertiser page is displayed (step S707).

Here, when the advertiser page return is not detected, the advertisement content type determining unit 310 of the page information/advertisement information providing device 3 temporarily determines the type of the advertisement content to be delivered to be the impression-guaranteed type for which cost can be charged when it is displayed (step S708).

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S709).

Then, the advertisement link embedding unit 312 of the page information/advertisement information providing device 3 embeds a link to the advertisement content determined by the advertisement content determining unit 311 into an advertisement space of the page generated by the page information generating unit 306 (step S710).

Then, the page transmitting unit 313 of the page information/advertisement information providing device 3 transmits the page information to the browser 21 of the terminal device 2 as the requestor (step S711).

Upon receiving the information, the browser 21 of the terminal device 2 renders and displays a screen based on the page information (step S712) and, during this process, sends an advertisement content request using the link embedded in the advertisement space (step S713).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requester (step S714).

After that, when the user of the terminal device 2 clicks the impression-guaranteed type advertisement content and browses an advertiser page (step S715), an advertiser page browse notification to the page information/advertisement information providing device 3 is performed using a notification description embedded in the advertisement space, and the notification is detected by the advertiser-page-return detecting unit 309 of the page information/advertisement information providing device 3 (step S716). The advertiser page may be provided by a server other than the page information/advertisement information providing device 3. When the advertiser page is provided by the page information/advertisement information providing device 3, the page information of the advertiser page is also provided by the page information/advertisement information providing device 3, though a detailed description thereof is not provided herein.

After that, when the browser 21 of the terminal device 2 sends a page browsing request and the page request receiving unit 305 of the page information/advertisement information providing device 3 receives the page browsing request (step S717), the page information generating unit 306 of the page information/advertisement information providing device 3 generates page information corresponding to the received page browsing request (step S718).

Then, the advertisement content type determining unit 310 of the page information/advertisement information providing device 3 refers to the advertiser-page-return detecting unit 309 to check if the advertiser-page-return detecting unit 309 detects an advertiser page return, in other words, if the page browsing request is a request to return to a previous page after the impression-guaranteed type advertisement content is clicked and the advertiser page is displayed (step S719).

In this situation, since the advertiser page return is detected, the advertisement content type determining unit 310 of the page information/advertisement information providing device 3 refers to the click index in the behavior history DB 322 using the user ID of the user (step S720), and determines which type of advertisement content between the impression-guaranteed type advertisement content and the pay-per-click type advertisement content to deliver (step S721). For example, when the click index is not more than a predetermined threshold value, the advertisement content type determining unit 310 determines the type of the advertisement content to be delivered to be the impression-guaranteed type for which cost can be charged when it is displayed since the possibility of clicking is low, whereas when the click index is more than the predetermined threshold value, the advertisement content type determining unit 310 determines the type of the advertisement content to be delivered to be the pay-per-click type for which a higher price can be charged.

Then, the advertisement content determining unit 311 of the page information/advertisement information providing device 3 determines a piece to be delivered from pieces of advertisement content of the type determined by the advertisement content type determining unit 310 and stored in the advertisement DB 321 (step S722). Here, when the advertisement content type determining unit 310 determines the type of advertisement content to be delivered to be the pay-per-click type, it is preferable that the advertisement content of the same advertisement subject (product or service) or advertisement content provided by the same advertiser be selected, since the impression-guaranteed type advertisement content in the previous stage is clicked and the advertiser page is browsed and there is a high possibility that the user is interested in the advertisement.

Then, the advertisement link embedding unit 312 of the page information/advertisement information providing device 3 embeds a link to the piece of advertisement content determined by the advertisement content determining unit 311 into an advertisement space of the page generated by the page information generating unit 306 (step S723).

Then, the page transmitting unit 313 of the page information/advertisement information providing device 3 transmits page information to the browser 21 of the terminal device 2 as the requestor (step S724).

Upon receiving the information, the browser 21 of the terminal device 2 renders and displays a screen based on the page information (step S725) and, during this process, sends an advertisement content request using the link embedded in the advertisement space (step S726).

When the advertisement request receiving unit 314 of the page information/advertisement information providing device 3 receives the advertisement content request, the advertisement transmitting unit 315 of the page information/advertisement information providing device 3 transmits corresponding advertisement content data to the browser 21 of the terminal device 2 as the requestor (step S727).

### CONCLUSION

As described above, an embodiment can provide the following advantages.

(1) Since the type of advertisement content is determined based on click index, the type of advertisement content to be delivered is determined to be an impression-guaranteed type for which cost can be charged when it is displayed when the possibility of clicking is low, and determined to be a pay-per-click type for which a higher price can be charged when the possibility of clicking is high. Thus, the charge amount of each advertisement space can be increased.

(2) Since the type of advertisement content is determined based on an accumulated advertisement space charge amount, the type of advertisement content to be delivered is determined to be an impression-guaranteed type for which cost can be charged when it is displayed until the accumulated charge amount reaches a predetermined amount, whereas the type is determined to be a pay-per-click type for which a higher price can be charged after the accumulated charge amount reaches the predetermined amount. This stabilizes the charge amount of each advertisement space.

(3) Since the type of advertisement content is determined based on an accumulated advertisement space charge amount and a click index, a further improvement of charge amounts can be expected compared to the case where the type is determined based on the accumulated advertisement space charge amount.

(4) Since the type of advertisement content is determined based on page display time, the type of advertisement content to be delivered is temporarily determined to be an impression-guaranteed type for which cost can be charged when it is displayed, whereas the type is determined to be a pay-per-click type for which a higher price can be charged when a predetermined period of time has elapsed and the possibility of clicking is high. This improves the charge amount of each advertisement space.

(5) Since the type of advertisement content is determined based on page display time and a click index, a further improvement of charge amounts can be expected compared to the case where the type id determined based only on page display time.

(6) Since the type of advertisement content is determined based on an advertiser page route, when a user views the advertisement for the first time, the type of advertisement content is determined to be an impression-guaranteed type for which cost can be charged when it is displayed, and when the user returns to the previous page after clicking the displayed advertisement content and viewing the advertiser's page, the type of the advertisement content to be displayed is determined to be a pay-per-click type for which a higher price can be charged because the possibility of re-clicking is high. Thus, charge amount of each advertisement space can be further improved.

(7) Since the type of the advertisement content is determined based on an advertiser page route and a click index, a further improvement of charge amounts can be expected compared to the case where the type is determined based on an advertiser page route.

According to the present invention, the profit can be increased by delivering impression-guaranteed type advertisement content and pay-per-click type advertisement content to a same advertisement space.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement information providing device, comprising:
an advertisement content storing unit configured to store impression-guaranteed type advertisement content and pay-per-click type advertisement content;
an advertisement content type determining unit configured to determine which type of advertisement content between the impression-guaranteed type advertisement content and the pay-per-click type advertisement content to deliver when a page browsing request is received from a terminal device of a user; and
an advertisement content delivery unit configured to determine advertisement content of the type determined by the advertisement content type determining unit among advertisement content stored in the advertisement content storing unit and deliver the advertisement content determined to an advertisement space included in a page for which the page browsing request is received from the terminal device of the user.

2. The advertisement information providing device according to claim 1, further comprising:
a behavior history storing unit configured to store behavior history of a user related to an advertisement display, and
a click index calculating unit configured to calculate a click index which indicates a clicking tendency of each user related to advertisements, based on the behavior history stored in the behavior history storing unit, wherein,
when a page browsing request is received from a terminal device of a user, the advertisement content type determining unit determines which type of advertisement content between the impression-guaranteed type advertisement content and the pay-per-click type advertisement content to deliver based on the click index of the user calculated by the click index calculating unit.

3. The advertisement information providing device according to claim 1, further comprising a unit configured to manage an accumulated charge amount of each advertisement space, wherein
the advertisement content type determining unit determines the impression-guaranteed type as the type of the advertisement content to deliver to the advertisement space until the accumulated amount becomes more than a predetermined value and determines the pay-per-click type as the type of the advertisement content after the accumulated charge amount becomes more than the predetermined value.

4. The advertisement information providing device according to claim 1, further comprising
a unit configured to insert a script, on a page including the advertisement space, for computing display time of the page and transmitting an advertisement switch request when a predetermined period of time elapses, wherein
the advertisement content type determining unit determines the impression-guaranteed type as a type of advertisement content to deliver when the page browsing request is received and determines the pay-per-click type as a type of advertisement content to deliver when the advertisement switch request is received.

5. The advertisement information providing device according to claim 1, wherein the advertisement content type determining unit determines the impression-guaranteed type as a type of advertisement content to deliver when the page browsing request is received and determines the pay-per-click type as a type of advertisement content to deliver when the page browsing request is received again after the impression-guaranteed type advertisement content is clicked and an advertiser page is displayed.

6. The advertisement information providing device according to claim 3, further comprising:
a behavior history storing unit configured to store behavior history of a user related to an advertisement display; and
a click index calculating unit configured to calculate a click index which indicates a clicking tendency of each user related to advertisements, based on the behavior history stored in the behavior history storing unit, wherein
the advertisement content type determining unit refers to a click index of the user calculated by the click index calculating unit before determining the pay-per-click type as a type of an advertisement and determines the pay-per-click type as a type of advertisement content when the click index is more than a predetermined value.

7. The advertisement information providing device according to claim 4, further comprising:
a behavior history storing unit configured to store behavior history of a user related to an advertisement display; and
a click index calculating unit configured to calculate a click index which indicates a clicking tendency of each user related to advertisements, based on the behavior history stored in the behavior history storing unit, wherein
the advertisement content type determining unit refers to a click index of the user calculated by the click index calculating unit before determining the pay-per-click type as a type of an advertisement and determines the pay-per-click type as a type of advertisement content when the click index is more than a predetermined value.

8. The advertisement information providing device according to claim 5, further comprising:
a behavior history storing unit configured to store behavior history of a user related to an advertisement display; and
a click index calculating unit configured to calculate a click index which indicates a clicking tendency of each user related to advertisements, based on the behavior history stored in the behavior history storing unit, wherein
the advertisement content type determining unit refers to a click index of the user calculated by the click index calculating unit before determining the pay-per-click type as a type of an advertisement and determines the pay-per-click type as a type of advertisement content when the click index is more than a predetermined value.

9. An advertisement information providing method executed by an advertisement information providing device, comprising:
storing impression-guaranteed type advertisement content and pay-per-click type advertisement content;
determining which type of advertisement content to deliver between the impression-guaranteed type advertisement content and the pay-per-click type advertisement content when a page browsing request is received from a terminal device of a user; and
determining advertisement content of the type determined in the determining among advertisement content stored in the storing and delivering the advertisement content determined to an advertisement space included in a page for which the page browsing request is received from the terminal device of the user.
